(19) United States
(12) Patent Application Publication
(10) Pub. No.: US 2021/0340020 A1
(43) Pub. Date: Nov. 4, 2021

(54) SURFACE MODIFIERS FOR PREPARING AGE-RESISTANT INORGANIC SALTS

(71) Applicant: The Shepherd Chemical Company, Cinicinnati, OH (US)

(72) Inventors: Roger Harrison, Lebanon, OH (US); Stephen D. Taylor, Taylor Mill, KY (US); William E. Schoster, Cincinnati, OH (US)

(21) Appl. No.: 17/324,226

(22) Filed: May 19, 2021

Related U.S. Application Data
(63) Continuation of application No. PCT/US19/51883, filed on Sep. 19, 2019.
(60) Provisional application No. 62/769,603, filed on Nov. 20, 2018.

(51) Int. Cl. C01G 3/08; C06B 33/04; C06B 23/00

(52) U.S. Cl. CPC C01G 3/08; C06B 33/04; C06B 23/007; C01P 2006/11; C01P 2006/12; C01P 2002/74; C01P 2004/03

(57) ABSTRACT

Humidity and temperature may impact the physical properties of Basic Copper Nitrate (BCN), (Cu₂(OH)₃(NO₃), BCN) inorganic particles. The use of hydrophobic surface coatings on these inorganic particles have been found to protect and/or minimize the amount of surface degradation over a period of time.

### RELATED APPLICATIONS

This application claims priority to provisional application 62/769,603, titled, “Surface Modifiers for Preparing Age-Resistant Inorganic Salts,” filed Nov. 20, 2018, the entire contents of which is hereby incorporated by reference.

### BACKGROUND

Industries that require highly reliable technologies depend on precisely engineered materials and processes to ensure consistent performance. For example, in the world's leading pyrotechnic airbag technology, a rapid reaction between Basic Copper Nitrate (BCN), and guanidine nitrate produces nitrogen gas, which inflates the airbag—producing life-saving results. The reaction between BCN and guanidine nitrate may be impacted by the physical properties of the two reactive components, such as particle size, surface area, porosity, density, and moisture content. Changes in these particle parameters could cause undesired changes in performance. For example, particles of ammonium nitrate utilized in airbags will undergo Ostwald ripening over repeated cycles of high humidity and temperature exposure. This process will gradually compromise the surface area of the ammonium nitrate leading to undesired, and at times catastrophic, results.

Airbag modules are manufactured by assembling a large number of components. Many components, especially those of metal or synthetic plastics are affected very little by the environment to which they are exposed while awaiting incorporation into the module or into a subassembly. Others, particularly chemicals such as those used to generate gases which inflate the airbag when it is being deployed, are susceptible to undesired reactions with one or more components of the atmosphere such as moisture or oxidizing gases.

### BRIEF DESCRIPTION OF FIGURES

FIG. 1. BCN Surface Area Measurements as a Function of Relative Humidity and Temperature (left); 3D scatter Plot of BCN Surface Area (SA) Measurements Over 5 Days of Exposure to Temperature (C) and Humidity (RH %), and the Corresponding Best Fit Plane (right)

FIG. 2. SEM Images of BCN after 5 day exposure to the following conditions: a) 8° C. and 5% RH; b) 50° C. and 50% RH; and c) 85° C. and 95% RH.

FIG. 3. XRD data of BCN after 5 day exposure to the following conditions: 80° C. and 95% RH (top), 50° C. and 50% RH (middle), and 85° C. and 95% RH (bottom).

FIG. 4. SEM images of CuO after 5 day exposure to the following conditions: a) 8° C. and 5% RH, and b) 85° C. and 95% RH.

FIG. 5. Dependence of BCN Stability on Packaging.

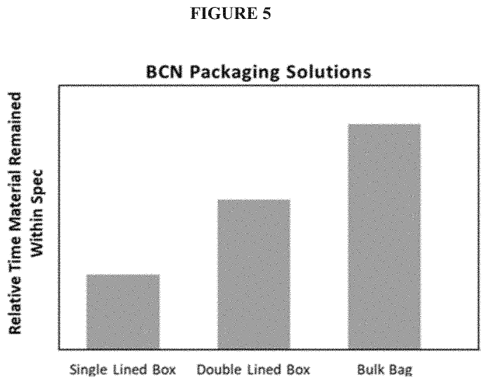

FIG. 6. Percent BCN surface area retained by additive at 1% treat rate. Conditions of 85° C. and 95% relative humidity for: control (no treatment), dextrose, sorbitol, and triethanolamine (TEA).

### BRIEF SUMMARY

The focus of this technology is the use of hydrophobic surface coatings on inorganic particles, namely BCN, Basic Copper Nitrate, (Cu(NO₃)₂.3H₂O) particles, which may be used in ballistic, gas generant and related types of highly exothermic applications. In this particular use, BCN is both an oxidant and burn rate modifier. Surface coatings have been found to protect and/or minimize the amount of surface degradation for such inorganic particles over a period of time.

Humidity and temperature impact the physical properties of BCN such as surface area, particle size, density, pH, and moisture content. Not being bound by theory, it is thought that particle evolution, including Ostwald ripening, play a role in particle degradation. The effects of temperature and humidity on the morphology of related materials have been examined, including copper oxide, copper nitrate crystals, and ammonium nitrate. In addition, it has been found that packaging and changes in particle preparation may impede the effects of temperature and humidity on critical parameters like surface area.

### DETAILED DESCRIPTION

A “gas generant” may be defined as a reactive chemical or system of chemicals that can be caused to intentionally produce a large amount of gas under specific conditions (ignition), typically suitable for inflating a part, chamber, or vessel.

“Ballistic” (ballistic composition or ballistic modifier) may be defined by those skilled in the art as a “recipe” of their propellant. Ballistics or “burn rate modifiers” are materials that compete with the combustion reaction to slow it down or quench it. These quenchers may be inorganic or metal organic salts where the metal has a redox couple that endothermally de-energizes the explosion, including but not limited to copper, lead, molybdenum, and bismuth.

Testing Procedures: Samples of BCN, copper nitrate crystals (Cu(NO₃)₂.3H₂O), and copper oxide (CuO) were prepared. Ammonium nitrate was purchased from Aldrich. Samples were aged in a CSZ ZP-8-2-H/AC Temperature/Humidity Test Chamber with a relative humidity (RH) range of 5 to 98±3% and a Temperature range of −34 to 190±0.5° C. For testing purposes, samples were stored in the chamber for 5 days at the designated conditions unless specified otherwise. Scanning electron microscopy (SEM) analysis was performed using a Hitachi SU5000. Samples were coated with gold using a Cressington 108Auto Sputter Coater for 60 seconds to limit charging. XRD measurements were conducted using a Rigaku Miniflex 600. Unless otherwise noted, x-ray powder diffractograms were recorded from 5 to 90 degree 2-theta with 40 kV voltage and 15 mA current. The instrument step size 0.05 degrees at a rate of 5 degrees/min. For BET measurements samples were degassed using a Micromeritics SmartPrep degasser and subsequent analysis was conducted using a Micromeritics Tristar 3020 surface analyzer. Bulk density was measured using a 50 mL graduated cylinder. Tap density was measured by tapping the sample 1000 times using a PharmaAlliance Group Tap Density Tester TD-12. Moisture content was measured at 80 and 105° C. using a Mettler HX204 moisture balance. pH measurements were conducted on a solution composed of 17.5 grams of the product in 20 mL of deionized water. Particle size analysis was conducted on either a Microtrac S3500 or Microtrac X100 analyzer.

TABLE 1
Table 1. BCN Surface Area Measurements as a Function
of Relative Humidity and Temperature (left); 3D scatter
Plot of BCN Surface Area (SA) Measurements Over 5 Days
of Exposure to Temperature (C.) and Humidity (RH %),
and the Corresponding Best Fit Surface (right)

| | | BCN Surface Area (m²/g) | | | | |
|---|---|---|---|---|---|---|
| Relative | 95%-RH | 3.28 | | 2.55 | 2.60 | 2.05 |
| Humidity | 75%-RH | | 2.83 | 2.26 | 2.06 | 1.90 |
| (%-RH) | 50%-RH | 4.15 | 3.87 | 3.16 | 2.99 | 2.18 |
| | 25%-RH | | 4.22 | 4.18 | 4.00 | |
| | 5%-RH | 4.56 | | 4.54 | | 4.10 |
| | 0 | 8° C. | 25° C. | 50° C. | 65° C. | 85° C. |

Temperature (° C.)

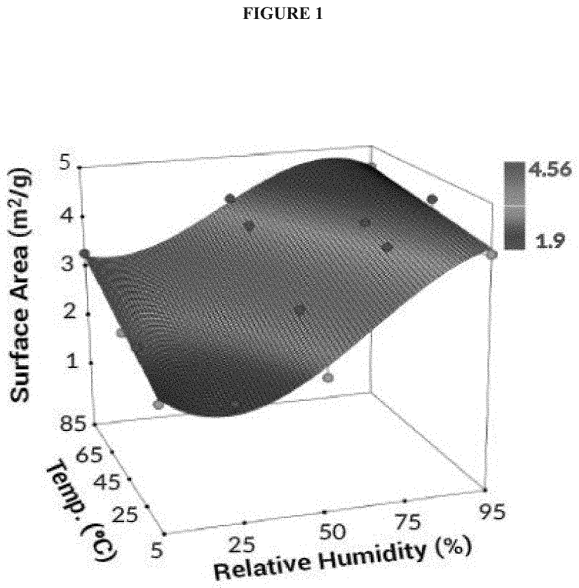

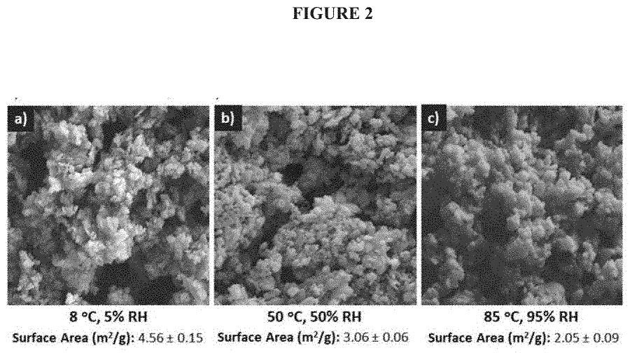

A recently manufactured lot of BCN was sampled and aged under temperature and relative humidity conditions ranging from 8-85° C. and 5-95% RH, respectively. All samples were analyzed for changes in surface area, particle size, density, SEM, and XRD. Of the properties measured, surface area (Table 1 and FIG. 1) and SEM (FIG. 2) data showed the most consistent behavior across all conditions. In general, surface area tends to decrease with increasing temperature. For instance, at a constant 5% RH, increasing the temperature from 8° C. to 85° C. resulted in a surface area decrease from 4.5 m²/g to 4.1 m²/g for an approximate 9% decrease. Similarly, but to a much greater extent, surface area decreases with increasing relative humidity. For instance, at a constant temperature of 8° C., increasing the relative humidity from 5% to 95% resulted in a surface area decrease from 4.5 m²/g to 3.3 m²/g, an approximate 26% decrease. The largest change in surface area is observed when both temperature and humidity are increased, resulting in a surface area of 2.05 m²/g at 85° C. and 95% RH—a 55% reduction in surface area. Under the most extreme conditions evaluated (i.e., low humidity/low temperature and high humidity/high temperature), the surface area levels off setting a maximum and a minimum for the experimental conditions. Data between these conditions were graphed and modeled (eq. 1).

Surface Area=3.24−1.81*(% RH)−0.84*(Temp.)−0.18*(% RH)*(Temp)+0.30*(% RH)²+0.47*(% RH)²*(Temp)+0.96*(% RH)³ (eq. 1)

Although both humidity and temperature have a direct impact on surface area, relative humidity is the major driving force in the coarsening process. Additionally, several of the equation factors show an interaction between temperature and humidity, consistent with accelerated ageing under increased relative humidity and temperature conditions. It is important to note that the data presented above was collected on a single manufactured lot of BCN. Within the 5 samples evaluated under each condition, the average standard deviation in the surface area measurement was 0.13 m²/g. Different manufactured lots of BCN evaluated in this study exhibited similar trends in surface area decrease with increasing temperature and relative humidity, however, the absolute change in surface area varied between each.

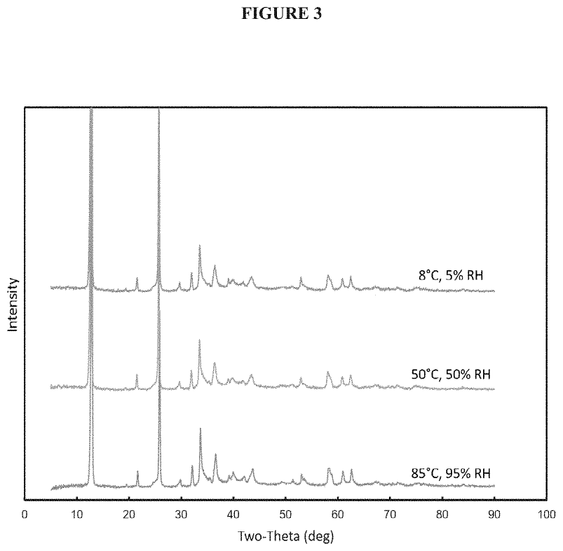

SEM images of BCN before and after exposure to heat and humidity reveal the physical morphology changes (FIG. 2) under the given set of conditions. At low temperature and humidity, the particles may be described as aggregates of small, plate-like crystals. At 50° C. and 50% RH, the particles appear larger and smoother than they do at the lowest conditions. At 85° C. and 95% RH, the particles are starting to grow together forming larger clumps consistent with decreased surface area and an Ostwald ripening-like process. Interestingly, preliminary kinetics studies show that decrease in surface area decay occurs within the first 24 hours. For instance, a sample of BCN with an initial surface area of 4.7 m²/g decreased to 2.6 m²/g within the first 24 hours of storage at 85° C. and 95% RH. The sample would continue to age over the next 4 days but only show an additional decrease of 0.4 m²/g. However, BCN exposed to 50% RH and 50° C. only resulted in a final surface area of 3.2 m²/g. This observation suggests that the decrease in surface area might be similar to an exponential decay process where the rate of decay is dependent on the humidity and temperature. However, more experiments are needed to elucidate this observation. Other characterization data like particle size, moisture content and density show some sample to sample variability, but nothing consistent with changes in temperature and humidity (Tables 2-7). XRD patterns of BCN showed no significant changes after exposure for 5 days, indicating that changes in surface area and particle morphology does not impact the crystalline lattice (FIG. 3). In other words, although samples are showing a decrease in surface area, the observed material is still BCN.

TABLE 2

| | | BCN Tap Density (g/mL) | | | | |
|---|---|---|---|---|---|---|
| Relative | 95%-RH | 0.70 | | 0.72 | 0.70 | 0.72 |
| Humidity | 75%-RH | | 0.68 | 0.69 | 0.67 | 0.67 |
| (%-RH) | 50%-RH | 0.70 | 0.70 | 0.68 | 0.68 | 0.69 |
| | 25%-RH | | 0.71 | 0.70 | 0.69 | |
| | 5%-RH | 0.70 | | 0.70 | | 0.72 |
| | 0 | 8° C. | 25° C. | 50° C. | 65° C. | 85° C. |

Temperature (° C.)

TABLE 5

| | | BCN Moisture Balance at 105° C. | | | | |
|---|---|---|---|---|---|---|
| Relative | 95%-RH | 0.39 | | 0.42 | 0.34 | 0.34 |
| Humidity | 75%-RH | | 0.39 | 0.37 | 0.29 | 0.28 |
| (%-RH) | 50%-RH | 0.32 | 0.35 | 0.27 | 0.26 | 0.21 |
| | 25%-RH | | 0.34 | 0.29 | 0.32 | |
| | 5%-RH | 0.30 | | 0.26 | | 0.26 |
| | 0 | 8° C. | 25° C. | 50° C. | 65° C. | 85° C. |

Temperature (° C.)

TABLE 3

| | | BCN Bulk Flow Density (g/mL) | | | | |
|---|---|---|---|---|---|---|
| Relative | 95%-RH | 0.46 | | 0.51 | 0.49 | 0.52 |
| Humidity | 75%-RH | | 0.45 | 0.51 | 0.46 | 0.47 |
| (%-RH) | 50%-RH | 0.484 | 0.48 | 0.45 | 0.48 | 0.48 |
| | 25%-RH | | 0.48 | 0.47 | 0.45 | |
| | 5%-RH | 0.48 | | 0.47 | | 0.50 |
| | 0 | 8° C. | 25° C. | 50° C. | 65° C. | 85° C. |

Temperature (° C.)

TABLE 6

| | | BCN pH | | | | |
|---|---|---|---|---|---|---|
| Relative | 95%-RH | 4.98 | | 5.16 | 5.05 | 4.81 |
| Humidity | 75%-RH | | 5.09 | 4.71 | 5.13 | 4.96 |
| (%-RH) | 50%-RH | 5.25 | 5.22 | 5.21 | 5.13 | 5.47 |
| | 25%-RH | | 5.27 | 5.23 | 5.25 | |
| | 5%-RH | 5.43 | | 5.30 | | 5.33 |
| | 0 | 8° C. | 25° C. | 50° C. | 65° C. | 85° C. |

Temperature (° C.)

TABLE 4

| | | BCN Moisture Balance at 80° C. | | | | |
|---|---|---|---|---|---|---|
| Relative | 95%-RH | 0.30 | | 0.32 | 0.21 | 0.29 |
| Humidity | 75%-RH | | 0.27 | 0.28 | 0.20 | 0.21 |
| (%-RH) | 50%-RH | 0.25 | 0.25 | 0.20 | 0.18 | 0.14 |
| | 25%-RH | | 0.26 | 0.19 | 0.24 | |
| | 5%-RH | 0.30 | | 0.16 | | 0.18 |
| | 0 | 8° C. | 25° C. | 50° C. | 65° C. | 85° C. |

Temperature (° C.)

TABLE 7

| | | BCN Particle Site Distribution (D₅₀) | | | | |
|---|---|---|---|---|---|---|
| Relative | 95%-RH | 4.44 | | 4.12 | 4.40 | 3.74 |
| Humidity | 75%-RH | | 4.36 | 4.29 | 4.48 | 4.99 |
| (%-RH) | 50%-RH | 4.20 | 4.16 | 4.25 | 4.31 | 5.01 |
| | 25%-RH | | 4.28 | 4.13 | 4.27 | |
| | 5%-RH | 4.04 | | 4.30 | | 3.85 |
| | 0 | 8° C. | 25° C. | 50° C. | 65° C. | 85° C. |

Temperature (° C.)

Tables 2-7. Impact of BCN ageing on the following particle properties: Tap Density (Table 2, top left), Flow Density (Table 3, middle left), pH (Table 4, bottom left), Moisture Content at 80° C. (Table 5, top right), Moisture Content at 105° C. (Table 6, middle right), and D₅₀ Particle Size Distribution (Table 7, bottom right)

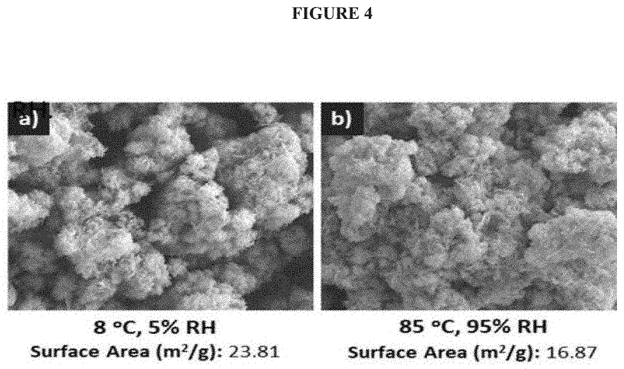

To understand how the ageing of BCN compares to related materials, the effect of temperature and humidity on ammonium nitrate (NH₄NO₃), copper nitrate crystals (Cu(NO₃)₂.3H₂O), and copper oxide (CuO) was examined. The solubilities of these materials vary greatly, with ammonium nitrate (297 g/100 mL at 40° C.) and copper nitrate crystals (381 g/100 mL at 40° C.) showing the greatest water solubility, followed by BCN (0.015 g/100 mL at 50° C.) and copper oxide (insoluble). It was anticipated that the materials with the greatest water solubility will be more susceptible to ageing. Similar to the BCN trials, samples of CuO, Cu(NO₃)₂.3H₂O and NH₄NO₃ were stored in temperatures and relative humidities ranging from 8° C. to 85° C. and 5% to 95%, respectively. Since ammonium nitrate and copper nitrate crystals are water soluble and exhibit deliquescence at ambient conditions, the materials dissolved under moderate temperatures and humidities preventing the collection of surface area data for these materials under many conditions. However, CuO showed similar behavior to BCN. Specifically, a sample of CuO with a starting surface area 24 m²/g decreased to 20.9, 17.8 and 16.9 m²/g after storage at 25° C. and 25% RH, 65° C. and 75% RH, and 85° C. and 95% RH for 5 days, respectively (Table 8). Unlike BCN, SEM images of CuO do not show definitive evidence of particle size growth due to Ostwald ripening (FIG. 4).

TABLE 8
Copper oxide surface area as a function
of temperature and relative humidity

| | | Copper Oxide Surface Area | | | | |
|---|---|---|---|---|---|---|
| Relative | 95%-RH | | | | | 16.87 |
| Humidity | 75%-RH | | | | 17.80 | |
| (%-RH) | 50%-RH | | | | | |
| | 25%-RH | | 20.94 | | | |
| | 5%-RH | 23.81 | | | | |
| | 0 | 8° C. | 25° C. | 50° C. | 65° C. | 85° C. |

Temperature (° C.)

More importantly, coating BCN with organic surfactants like Triton x-100 or polyols like glycerol may effectively protect the BCN particles from ageing. Surface modification applied during the synthesis process may impact how BCN ages in the presence of elevated temperatures and moisture (Table 2). For instance, 5 samples of BCN prepared with 1% glycerol showed no significant change in surface area after exposure to 95% relative humidity and 50° C. for 5 days. However, standard BCN exhibited an approximate 30% drop in surface area over the same period of time.

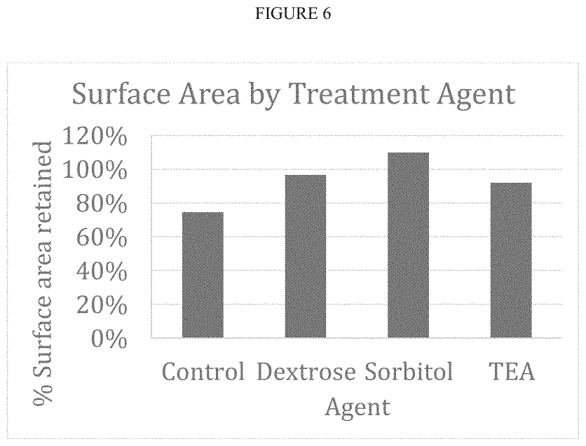

Other coating materials tested for BCN include dextrose, sorbitol and alkanolamines such as triethanolamine, THEED and THPED. Surface area data and a bar chart showing the surface area of the abused samples are shown in FIG. 6. The conditions tested were 85° C. and 95% rel. humidity for 5 days. The hydrophobic surface coating is about 0.1 to about 5% by weight of the total mass of particles, between about 0.5% and 4% of the total mass of particles, and between 1% and 3% of the total mass of particles.

TABLE 9
Surface area measurements before and after exposure to
50° C. and 95% RH for samples of BCN prepared with
the standard synthesis vs. proprietary BCN synthesis

| | Surface Area Measurement | Surface Area Measurement |
|---|---|---|
| | Before Exposure (m²/g) | After Exposure (m²/g) |
| Standard BCN | 4.77 | 3.43 |
| Proprietary | 4.72 ± 0.22 | 4.54 ± 0.10 |
| BCN Synthesis | | |

As seen with BCN, CuO, and Cu(NO₃)₂.3H₂O, most inorganic materials will age over time as they are exposed to different environmental conditions. This may have an impact on applications where performance depends on consistent particle properties like surface area, particle size, porosity and others. Not being bound by theory, it is thought that BCN undergoes environmental ageing through an Ostwald ripening-like process. However, the limited solubility of BCN makes the ripening process more like that of CuO as opposed to Cu(NO₃)₂.3H₂O and NH₄NO₃ which dissolve under conditions above 50° C. and 50% RH. SEM data provides further verification that the ageing process involves increasing the size of the primary particles and sintering of the aggregated particles through an Ostwald ripening-like process which results in the decrease of surface area. Despite the changes in particle morphology, the crystalline morphology remains unchanged under the conditions evaluated in this study, therefore BCN remains as BCN. Other physical properties like particle size, density, moisture and pH did show some variability, but not consistent with changes in temperature or relative humidity. Accordingly, coating BCN with glycerol may make the particle surface hydrophobic and therefore reduce and/or eliminate particle ageing. This method of treating chemicals where surface properties are vital for performance, as in ballistic applications and gas generant compositions, may be critical for ensuring long term, consistent performance.

What is claimed:

1) Basic Copper Nitrate (BCN) particles, of the chemical formula Cu₂(OH)₃(NO₃), for use in ballistic and gas generant applications, wherein said particles are coated with a hydrophobic surface coating.

2) The particles of claim 1, wherein the hydrophobic surface coating is selected from organic surfactants, polyols, alkanolamines and combinations thereof.

3) The particles of claim 2, wherein the hydrophobic surface coating is selected from the group consisting of glycerin, dextrose, sorbitol and triethanolamine.

4) The particles of claim 1, wherein the hydrophobic surface coating is glycerin.

5) The particles of claim 2, wherein the hydrophobic surface coating is about 0.1 to about 5% by weight of the total mass of particles.

6) The particles of claim 2, wherein the hydrophobic surface coating is about 0.5 to about 4% by weight of the total mass of particles.

7) The particles of claim 4, wherein the hydrophobic surface coating is about 0.1 to about 5% by weight of the total mass of particles.

8) The particles of claim 4, wherein the hydrophobic surface coating is about 0.5 to about 4% by weight of the total mass of particles.

9) The particles of claim 4, wherein the hydrophobic surface coating is about 1% to about 3% by weight of the total mass of particles.

10) A ballistic basic copper nitrate composition treated with a hydrophobic surface modifying substance.

11) The ballistic basic copper nitrate composition of claim 10 wherein the surface modifying substance is selected form the group consisting of organic surfactants, polyols and combinations thereof.

12) The ballistic basic copper nitrate composition of claim 11 wherein the surface modifying substance is about 0.1 to about 5% by weight of the total mass of particles.

13) The ballistic basic copper nitrate composition of claim 11 wherein the surface modifying substance is about 0.5 to about 4% by weight of the total mass of particles.

14) The ballistic basic copper nitrate composition of claim 10, wherein the hydrophobic surface coating is glycerin.

15) The ballistic basic copper nitrate composition of claim 10, wherein the hydrophobic surface coating is about 0.1 to about 5% by weight of the total mass of particles.

16) The ballistic basic copper nitrate composition of claim 10, wherein the hydrophobic surface coating is about 0.5 to about 4% by weight of the total mass of particles.

17) The ballistic basic copper nitrate composition of claim 10, wherein the hydrophobic surface coating is about 1% to about 3% by weight of the total mass of particles.
